(19) United States
(12) Patent Application Publication
(10) Pub. No.: US 2025/0311869 A1
(43) Pub. Date: Oct. 9, 2025

(54) DEVICE, SYSTEM, AND METHOD FOR TAMPER DETECTION

(71) Applicant: SIP BUDDY, INC., Lincoln, NE (US)

(72) Inventor: Joseph Ryan Flodman, Lincoln, NE (US)

(21) Appl. No.: 19/097,395

(22) Filed: Apr. 1, 2025

Related U.S. Application Data
(60) Provisional application No. 63/573,647, filed on Apr. 3, 2024.

(51) Int. Cl. A47G 19/22; G06T 7/20; G06V 20/52; G06V 40/16

(52) U.S. Cl. CPC A47G 19/2227; G06T 7/20; G06V 20/52; G06V 40/161; G06V 40/172; A47G 2400/123

(57) ABSTRACT

A device for protecting against tampering includes connecting means for removably connecting the device to a vessel, and imaging means for capturing frames of one or more imaging areas while the device is removably connected to the vessel via the connecting means. The one or more imaging areas include at least one imaging area corresponding to an opening of the vessel. The device further includes processing means for detecting, based on the captured frames, a potential tampering with the vessel or contents of the vessel, and alerting means for visually indicating the potential tampering.

### CROSS-REFERENCE TO RELATED APPLICATIONS

This application claims the benefit of U.S. Provisional Patent Application No. 63/573,647, entitled “Device, System, and Method for Tamper Detection” and filed on Apr. 3, 2024, the entire disclosure of which is hereby incorporated herein by reference.

### FIELD OF THE DISCLOSURE

The present disclosure generally relates to personal safety technology and, more specifically, to devices, systems, and methods for detecting unwanted tampering with a beverage or food.

### BACKGROUND

Malicious tampering or “spiking” of drinks/beverages is a problem that affects, directly or indirectly, millions of people each year. Drink spiking is particularly problematic in certain settings, such as college campuses and crowded bar or club environments, although it can occur virtually anywhere. Moreover, drink spiking can be accomplished with a wide variety of substances, with some of the drugs that are more frequently used for spiking being gamma-hydroxybutyrate (GHB), gamma-butyrolactone (GBL), tranquilizers such as benzodiazepines, and ketamine. A victim of drink spiking may be subjected to sexual assault, other physical assault, and/or other harm, resulting in near-term trauma and, in many cases, long-term trauma to not only the victim but also family and friends.

Given the gravity and scope of the problem, a number of solutions have been proposed and/or offered on the market. For example, companies have offered test strips that can detect drink tampering by acting as a chemical sensor (e.g., changing color if a particular chemical compound is present). However, test strips suffer from various drawbacks and inconveniences. Test strips require contact with the drink itself, are typically not reusable (such that many may be needed even in the course of a single night or single excursion), and may be limited to detecting only a specific substance/compound or a very limited range of substances/compounds. Moreover, test strips may provide false negatives in certain situations, such as when a bad actor drops a pill into a drink and the pill has not yet dissolved sufficiently to interact with the test strip. Test “drops” (i.e., introducing, into the drink, a substance that changes color when chemically interacting with specific, undesired substances) suffer from many of the same drawbacks as test strips.

Another commercially available solution is to provide a physical covering or cap for a user's drink. This can be superior to test strips or test drops in the sense that the cap can potentially prevent spiking in the first instance, is not limited to protecting against particular type or form of drugs, and is more likely to be reusable. However, it is relatively easy to overcome the protections offered by such a cap. For example, a bad actor can simply wait for an opportunity to surreptitiously raise the cap (e.g., while the person drinking the beverage has gone to the restroom) to introduce a drug.

Furthermore, all of the aforementioned mechanisms (test strips, test drops, and drink covers/caps) suffer from the drawback that, even if tampering is detected, they typically offer little or no information regarding who tampered with the drink, or how or when the tampering occurred. Thus, these solutions cannot facilitate efforts to identify perpetrators and hold them accountable for their misdeeds.

### BRIEF SUMMARY

In one aspect, a device for protecting against tampering includes connecting means for removably connecting the device to a vessel, and imaging means for capturing frames of one or more imaging areas while the device is removably connected to the vessel via the connecting means. The one or more imaging areas include at least one imaging area corresponding to an opening of the vessel. The device also includes processing means for detecting, based on the captured frames, a potential tampering with the vessel or contents of the vessel, and alerting means for visually indicating the potential tampering.

In another aspect, a method for protecting against tampering includes capturing, by a device, frames of one or more imaging areas while the device is removably connected to the vessel. The one or more imaging areas including at least one imaging area corresponding to an opening of the vessel. The method also includes detecting, by the device and based on the captured frames, a potential tampering with the vessel or contents of the vessel, and providing, by the device, an alert that includes a visual indication of the potential tampering.

In another aspect, a method for protecting against tampering includes wirelessly receiving, by a mobile computing device and from a device removably connected to a vessel, a message indicating potential tampering with the vessel or contents of the vessel. The method also includes presenting, on a display of the mobile computing device and in response to wirelessly receiving the message, an alert indicating the potential tampering.

### BRIEF DESCRIPTION OF THE DRAWINGS

The figures described below depict various aspects of the systems and methods disclosed herein. It should be understood that each figure depicts a possible embodiment of a particular aspect of the disclosed systems or methods.

FIG. 1 is a block diagram of an example tamper detection system, according to one embodiment.

FIGS. 2A and 2B depict an example tamper detection device, and connecting means thereof, respectively, according to one embodiment.

FIGS. 3-5 depict various example tamper detection devices, according to alternative example embodiments.

FIG. 6 depicts an example arrangement of imaging areas for a tamper detection device, according to one embodiment.

FIGS. 7A and 7B depict example charging cases for a tamper detection device, according to two alternative embodiments.

FIG. 8 is a flow diagram of an example algorithm for determining whether to alert a user of a tamper detection device, according to one embodiment.

FIG. 9 is a flow diagram of an example method, performed by a device, for protecting against tampering.

FIG. 10 is a flow diagram of an example method, performed by a mobile computing device communicatively coupled to another device, for protecting against tampering.

### DETAILED DESCRIPTION

### I. Overview

The embodiments described herein relate to, inter alia, systems, methods, and techniques for detecting tampering with a vessel and/or its contents. In general, a tamper detection device is configured to be removably connected to a vessel (e.g., clipped, or hung by a bracket, etc., on to the rim of a glass, cup, can, etc.), and includes at least one imaging device such as a wide-angle camera. The tamper detection device is further configured to detect, based on one or more captured frames/images (e.g., frames of video), an attempt to tamper with the vessel and/or the vessel contents, and to alert a user when such tampering is detected (e.g., by activating one or more light-emitting diodes (LEDs) of the tamper detection device). The tamper detection device may be communicatively coupled (e.g., via Bluetooth, WiFi/IEEE 802.11, or another wireless communication protocol) to a computing device such as the user's mobile device (e.g., a smartphone or smart watch) to provide further functionality, as discussed in greater detail below.

As used herein, the term “drink” can encompass a beverage within a vessel (e.g., a glass, cup, etc.), and/or the vessel itself, unless a more specific meaning is clearly indicated by the context of its use. Thus, for example, detection of “drink tampering” can refer herein to detecting that the beverage within a vessel was tampered with (e.g., by dropping a substance into the beverage), detecting that the vessel itself was tampered with (e.g., by depositing a substance on a rim of a glass containing a beverage), or detecting some combination of both (e.g., if a liquid drug dispensed from an eye dropper both coats part of a glass and falls into a beverage within the glass). Moreover, while the description herein primarily uses beverage (drink) tampering as an example, it is understood that the devices, systems, and methods described herein can instead be used to prevent tampering with food within a vessel (e.g., soup in a bowl, a snack mix in a dish, ice cream in a cup, etc.).

### II. Example Tamper Detection System

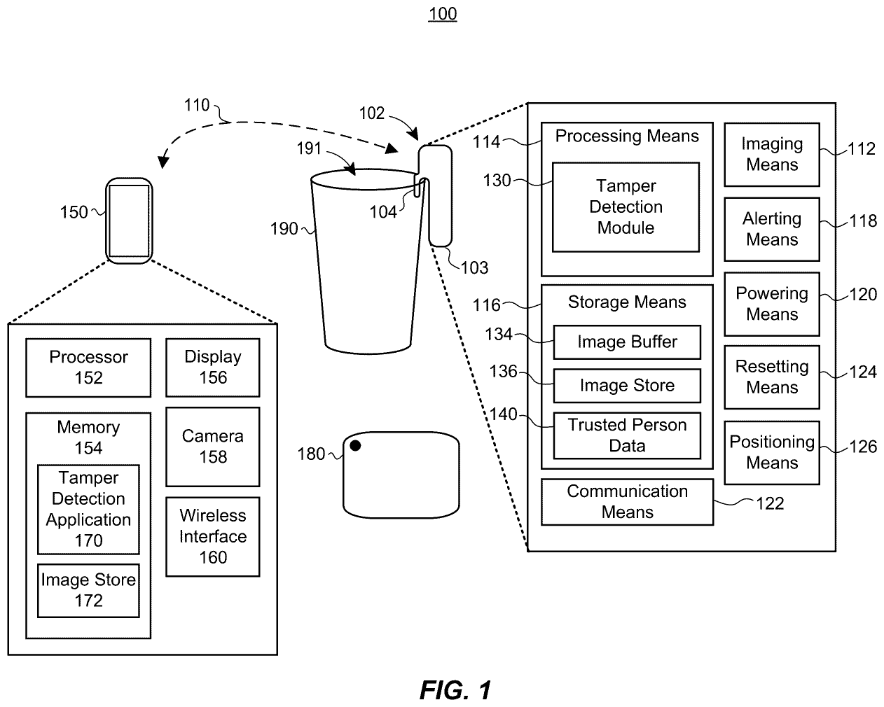

FIG. 1 is a simplified block diagram of an example system 100 that may be used to implement one or more techniques of the present disclosure. The example system 100 includes a tamper detection device 102 having a connecting means 104 for removably connecting the tamper detection device 102 to a vessel 190 having an opening 191. The vessel 190 may be any type of container suitable for holding a beverage or food, such as a glass, cup, mug, can, bowl, and so on. The example system 100 also includes a mobile computing device 150, which may belong to the same person who owns tamper detection device 102, for example. FIG. 1 depicts an embodiment in which mobile computing device 150 is a smartphone. In other embodiments, however, mobile computing device 150 may be a smart watch, smart glasses, a distributed device (e.g., a combination of a smartphone and a coupled smart watch), or another suitable computing device. In some embodiments, mobile computing device 150 is configured to wirelessly communicate with tamper detection device 102, and vice versa, via a wireless link 110 as discussed further below. In other embodiments, however, tamper detection device 102 operates entirely independently, and the system 100 excludes mobile computing device 150.

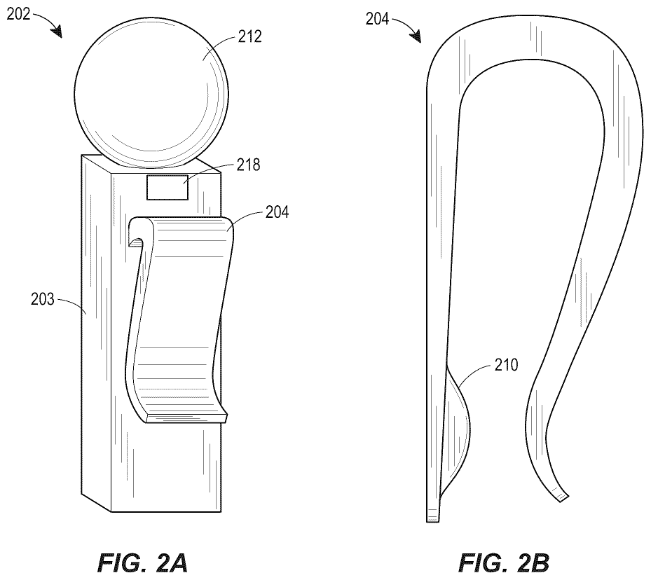

The connecting means 104 of the tamper detection device 102 may be any mechanism suitable for temporarily connecting the tamper detection device 102 to the vessel 190, such as a clip configured to clip onto the rim of the vessel 190, a clamp configured to clamp onto the rim of the vessel 190, or, as shown in FIG. 1, a bracket configured to rest on the rim of the vessel 190. In other embodiments, however, the connecting means 104 can removably connect the tamper detection device 102 to the vessel 190 in another way, such as by adhesive material on the tamper detection device 102, or one or more suction cups on the tamper detection device 102, etc. The connecting means 104 allows a user to connect or disconnect/remove the tamper detection device 102 from the vessel 190 without damaging the connecting means 104, the rest of tamper detection device 102, or the vessel 190. Tamper detection device 102 also includes a body 103 that is connected to (e.g., monolithically formed with or otherwise permanently connected to) the connecting means 104. The body 103 may be formed from polycarbonate, polypropylene, or any other suitable material (e.g., any suitable rigid material). Example configurations/form factors of the tamper detection device 102 are shown and discussed in more detail below in connection with FIGS. 2-6.

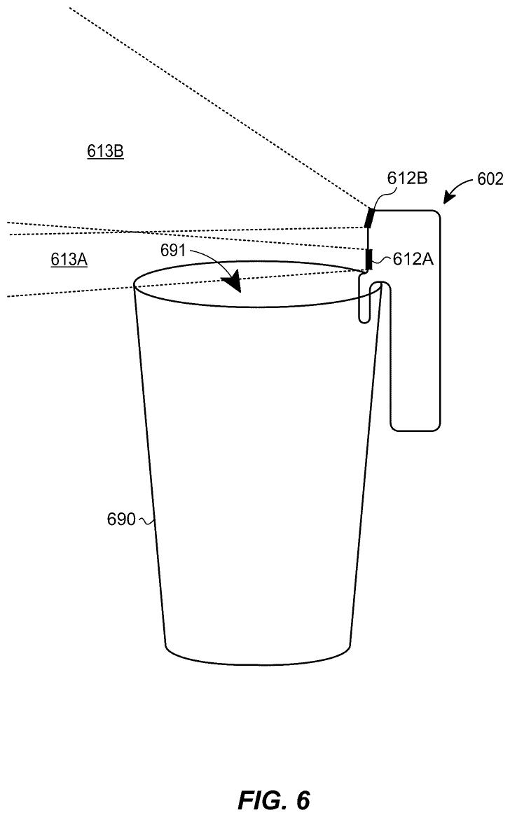

On (and/or partially within) the body 103 of the tamper detection device 102 are imaging means 112, for capturing frames of one or more imaging areas while the tamper detection device 102 is removably connected to the vessel 190 via the connecting means 104. These imaging area(s) include at least one imaging area corresponding to the opening 191 of the vessel 190 (e.g., encompassing the entire opening 191, or at least substantially the entire opening 191, and/or the entirety of an imaging area proximate to and above the opening 191). Example imaging areas are discussed in further detail below in connection with FIG. 6. The imaging means 112 may include one or more cameras configured to capture images/frames at any suitable rate (e.g., 30 frames per second, 10 frames per second, 1 frame per second, etc.). In some embodiments, the imaging means 112 includes a camera having a wide-angle lens with a short focal length, to enable clear imaging of the entire vessel opening 191 and/or an imaging area just above the opening 191. Additionally or alternatively, the imaging means 112 may include a camera with a longer focal length, to enable clear imaging of objects (e.g., faces) further away from the vessel 190. In some embodiments, the imaging means 112 includes (e.g., instead of or in addition to camera(s)) one or more other components configured to capture different types of images, such as an infrared camera or a LIDAR device. For example, imaging means 112 may include a LIDAR device (or sonar device, etc.) configured to image a first imaging area that includes vessel opening 191, and also include one or more cameras configured to image a second imaging area that extends further away from the vessel 190 than the first imaging area (e.g., to capture faces of people nearby and possibly other objects).

Within the body 103, the tamper detection device 102 includes processing means 114, for detecting, based on frames captured by the imaging means 112, potential tampering with the vessel 190 or its contents. The processing means 114 include one or more processors, such as a central processing unit (CPU) and/or a graphical processing unit (GPU). The processing means 114 can also include one or more persistent memory components (i.e., one or more non-transitory, computer-readable media) that store software instructions that the one or more processors is/are configured to execute. In the example embodiment of FIG. 1, the instructions stored in memory of the processing means 114 include instructions of a tamper detection module 130 that is generally configured to detect potential tampering by analyzing/processing frames captured by the imaging means 112, and possibly also communicate, via wireless link 110, with the mobile computing device 150. Tamper detection module 130 is discussed in greater detail below. In some embodiments, the processing means 114 includes only processors that do not execute software instructions (e.g., application-specific integrated circuits (ASICs), field-programmable gate arrays (FPGAs), etc.), in which case the functionality of tamper detection module 130 is executed without software (e.g., if relatively simplistic processing is employed, such as generating an alert signal based on any change from one frame to the next, for an imaging area restricted to the immediate vicinity of the vessel opening 191). The processing means 114 may be electrically coupled, directly or indirectly, to the imaging means 112, as well as the storage means 116, alerting means 118, communication means 122, resetting means 124, and positioning means 126 (all discussed below), to receive inputs and/or provide outputs/control signals as necessary for the various operations herein.

Within the body 103, the tamper detection device 102 also includes storage means 116. The storage means 116 may include one or more volatile and/or non-volatile memories. Any suitable memory type or types may be included in the storage means 116, such as a read-only memory (ROM) and/or a random access memory (RAM), a flash memory, a solid-state drive (SSD), and so on. As discussed in further detail below, the storage means 116 may include an image buffer 134 for short-term storage of images/frames, an image store 136 for longer-term/persistent storage of images/frames, and trusted person data 140 indicative of facial features of one or more trusted individuals. Image buffer 134 may be any suitable type of buffer with any suitable size (e.g., sufficient to store the 10 most recently captured frames, or the 100 most recently captured frames, etc.).

On (and/or partially within) the body 103 of the tamper detection device 102 are also alerting means 118, for visually indicating potential tampering detected by the tamper detection module 130 (i.e., providing a visual alert that indicates that tampering may have occurred). The alerting means 118 may include one or more light-emitting diodes (LEDs), for example, which the tamper detection module 130 triggers (i.e., causes current to pass through the LEDs) when detecting a potential tampering risk or event. In some embodiments, the alerting means 118 also includes one or more other elements, in addition to the visual indicator. For example, the alerting means 118 may also include a speaker, with the tamper detection module 130 causing the speaker to emit sound when detecting a potential tampering risk or event. As another example, the alerting means 118 may also include a vibration element, with the tamper detection module 130 causing the element (and thus, the entire device 102) to vibrate when detecting a potential tampering risk or event. Generally, however, it is preferable that the alerting means 118 at least include a visual indicator, to provide effective alerts even in noisy environments (e.g., bars, clubs, sporting events, etc.).

Within the body 103, the tamper detection device 102 also includes powering means 120 for providing, via one or more batteries of powering means 120, power to the tamper detection device 102 and, in some embodiments, for charging the one or more batteries when the tamper detection device 102 is coupled to the charging device 180 (discussed below). The batteries of the powering means 120 may be rechargeable batteries, such as lithium-ion batteries or any other suitable type of rechargeable battery. To facilitate recharging the one or more batteries, the powering means 120 may include a Universal Serial Bus (USB) port or other suitable connector type, or circuitry for wireless charging of the one or more batteries. In other embodiments, the powering means 120 instead, or additionally (e.g., as backup power), includes one or more disposable/replaceable batteries, e.g., with the body 103 including a removable cover over a battery compartment configured to carry the one or more batteries. The powering means 120 may be electrically coupled, directly or indirectly, to the imaging means 112, processing means 114, alerting means 118, communication means 122 (discussed below), and positioning means 126 (also discussed below), and possibly also the storage means 116, to provide power to the respective electrical components.

Within the body 103 (and possibly also on or external to the body 103), the tamper detection device 102 also includes communication means 122 for wirelessly transmitting data to (and possibly also receiving data from) the external mobile computing device 150 via the wireless link 110. The communication means 122 may include hardware, firmware, and/or software to enable wireless communication with the mobile computing device 150 according to any suitable wireless communication protocol, such as Bluetooth, WiFi/IEEE 802.11, and so on. For example, the communication means 122 may include one or more antennas, front-end hardware, and baseband circuitry of a transceiver, as well as components for higher-layer functionality.

The tamper detection device 102 also includes resetting means 124 for disabling an active alert and/or initializing a monitoring mode of the tamper detection device 102. Resetting means 124 may include a physical button on a surface of the body 103, along with associated circuitry for generating an electrical signal indicating that the button has been pressed. User activation of the button can either briefly interrupt power provided by powering means 120 to processing means 114, or generate/trigger an electrical signal that causes processing means 114 (e.g., tamper detection module 130) to restart or initialize a tamper detection process or algorithm, for example. In other embodiments, resetting means 124 is omitted from tamper detection device 102. For example, the tamper detection module 130 may provide reset functionality based on a signal received at the tamper detection device 102 from the mobile computing device 150 via wireless link 110 (e.g., when a user selects a reset option via the display 156 of the mobile computing device 150).

Within the body 103 (and possibly also on or external to the body 103), the tamper detection device 102 also includes positioning means 126 for determining a geographic location of the tamper detection device 102. For example, the positioning means 126 may include a global navigation satellite system (GNSS) unit, such as a global positioning system (GPS) unit.

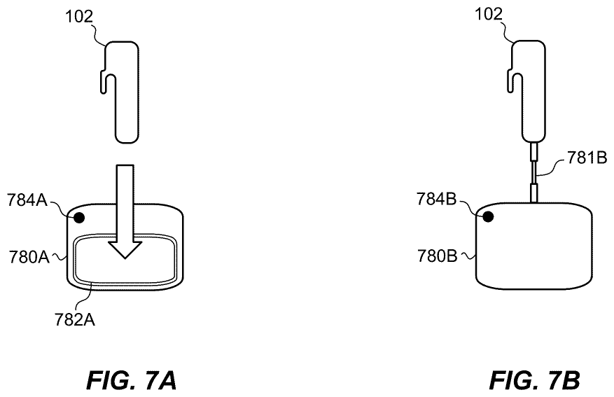

In the embodiment of FIG. 1, the system 100 also includes a charging device 180. Charging device 180 is generally configured to recharge one or more internal, rechargeable batteries of the tamper detection device 102 (included in powering means 120) when needed. Example charging devices are discussed in further detail below in connection with FIGS. 7A and 7B. In other embodiments, the system 100 excludes charging device 180. For example, tamper detection device 102 may instead recharge solely by coupling (e.g., via a USB or other suitable connector type) to a power outlet charger block, or to a laptop, etc., or may use only non-rechargeable batteries.

The mobile computing device 150 includes a processor 152, a memory 154, a display 156, a camera 158, and a wireless interface 160. The processor 152 may include one or more CPUs and/or GPUs, and the memory 154 may include any suitable volatile and/or non-volatile memory unit(s). The display 156 may be a liquid crystal display (LCD), LED display, or any other suitable type of display. The wireless interface 160 may include hardware, firmware, and/or software to enable wireless communication with the tamper detection device 102, via wireless link 110, according to the same wireless communication protocol supported by communication means 122 (e.g., Bluetooth, WiFi/IEEE 802.11, etc.).

The memory 154 stores instructions of a tamper detection application 170, which can be executed by processor 152 to perform various operations of mobile computing device 150 described herein. Generally, the tamper detection application 170 may communicate with the tamper detection device 102, provide outputs to the user based on activity detected by the tamper detection device 102, and/or enable user management of the tamper detection device 102. The memory 154 also includes an image store 172 to provide long-term storage of images/frames received from the tamper detection device 102. While not shown in FIG. 1, the mobile computing device 150 may also include one or more input components, such as a keypad and/or microphone. In some embodiments, the display 156 also operates as an input component (e.g., a touch screen).

### III. Example Tamper Detection Devices

Before discussing operation of the system 100 in further detail, some example embodiments of the tamper detection device 102 are discussed with reference to FIGS. 2-6, and example embodiments of the charging device 180 are discussed with reference to FIGS. 7A and 7B.

Referring first to FIG. 2A, an example tamper detection device 202 includes a generally cuboid-shaped body 203 (e.g., body 103) to which a spring clip 204 (e.g., connecting means 104) is permanently affixed. The spring clip 204 may be formed from a suitable metal material, for example, possibly with a suitable coating to protect a vessel (e.g., vessel 190) from scratches. As seen in FIG. 2B, the spring clip 204 may include a dimple 210 to more tightly grip the wall of the vessel. The tamper detection device 202 also includes a camera, such as a wide-angle lens camera or a 360-degree lens camera (or multiple cameras collectively providing a 360-degree view, etc.), within a radome-like housing 212. The camera(s) contained within the housing 212 may be a part of the imaging means 112, for example. In various embodiments, the housing 212 may be translucent, or tinted, etc. The tamper detection device 202 also includes an LED indicator 218 (e.g., at least a part of alerting means 118).

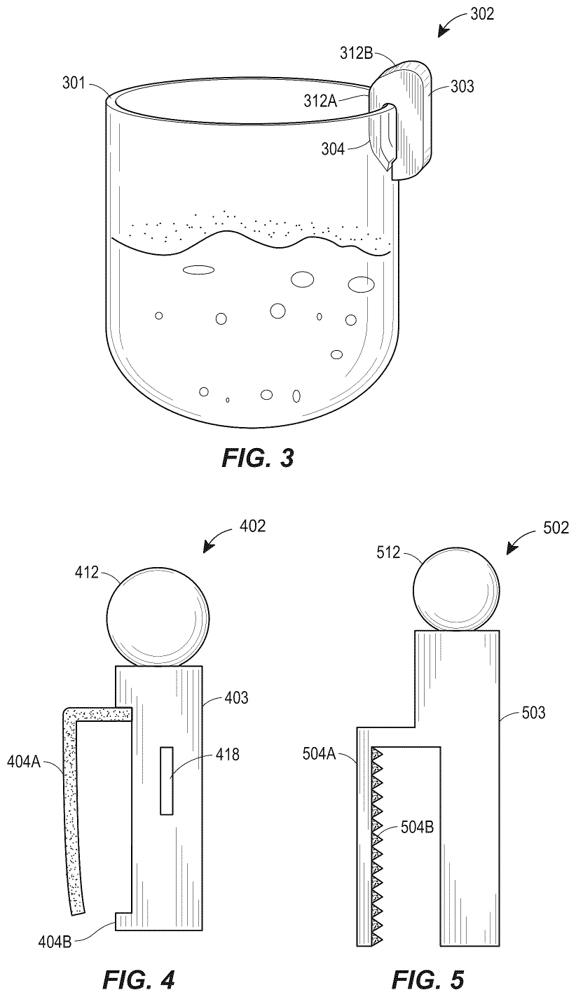

Turning next to FIG. 3, an example tamper detection device 302 is shown clipped to a glass 301. The tamper detection device 302 is monolithically formed such that the clip 304 (e.g., connecting means 104) is an extension of the body 303 (e.g., body 103) itself. The clip 304 may be a spring clip, or may not provide any spring action (e.g., if the material of the body 303 and clip 304 is too rigid to form a spring clip). While not visible in FIG. 3 due to the perspective view, the tamper detection device 302 may include a first camera 312A with an imaging axis that travels substantially in parallel with the plane of the opening of the glass 301, and a second camera 312B with an imaging axis that is angled up relative to the plane of the opening of the glass 301. Collectively, cameras 312A and 312B may form the imaging means 112.

Turning next to FIG. 4, an example tamper detection device 402 includes a body 403 (e.g., body 103) to which a bracket 404A is permanently affixed. The body 403 at one end includes a lip 404B, such that, when the tamper detection device 402 is mounted/hung on a vessel, the lip 404B and at least the top of the bracket 404A make contact with the vessel wall, and/or the lip 404B and the end of the bracket 404A act in concert to “pinch” the vessel wall. Collectively, the bracket 404A and lip 404B may form the connecting means 104. The bracket 404A may be formed from any suitable material, possibly with a suitable coating to protect a vessel (e.g., vessel 190) from scratches. The bracket 404A may be slightly flexible to function similar to a spring clip, or may be rigid. The tamper detection device 402 also includes one or more cameras, such as a wide-angle lens camera or a 360-degree camera (or collection of cameras providing 360-degree coverage, etc.), within a radome-like housing 412. The camera(s) contained within the housing 412 may be a part of the imaging means 112, for example. In various embodiments, the housing 412 may be translucent, or tinted, etc. The tamper detection device 402 also includes a reset button 418 (e.g., at least a part of resetting means 124).

Turning next to FIG. 5, an example tamper detection device 502 includes a body 503 (e.g., body 103) to which a bracket 504A is permanently affixed. The bracket 504A may be formed from any suitable material. In this example embodiment, the bracket 504A includes a protective inner surface 504B, which may be any material suitable to protect the wall of the vessel (e.g., rubber, felt, etc.). Collectively, the bracket 504A and protective inner surface 504B may form the connecting means 104. The bracket 504A may be slightly flexible to function similar to a spring clip, or may be rigid. The tamper detection device 502 also includes one or more cameras, such as a wide-angle lens camera or a 360-degree camera (or collection of cameras providing 360-degree coverage, etc.), within a radome-like housing 512. The camera(s) contained within the housing 512 may be a part of the imaging means 112, for example. In various embodiments, the housing 512 may be translucent, or tinted, etc.

In some embodiments, certain tamper detection devices discussed above (e.g., device 102, 202, 402, or 502) have imaging means that provide a wide-angle view and short focal distance, to capture images/frames of only the opening of the vessel (e.g., opening 191) or an area proximate to the opening. In other embodiments, however, other imaging arrangements are employed. FIG. 6 depicts one such example arrangement, in which a tamper detection device 602 (e.g., device 102) includes cameras 612A and 612B (e.g., imaging means 112, collectively) that, when mounted on a wall of a vessel 190, provide a field of view covering two respective imaging areas 613A and 613B. An imaging arrangement similar to that of FIG. 6 may also be provided by the imaging means of tamper detection device 302, for example.

As seen in FIG. 6, the first imaging area 613A covers the entire (or at least substantially the entire) opening 691 of the vessel 690, as well as the space immediately above the opening 691. Thus, the camera 612A may have a short focal length, and a wide angle (horizontally) such as at least 60 degrees, at least 70 degrees, or at least 90 degrees. While shown with a narrow angle in the vertical direction, the camera 612A may be equally wide-angle in the vertical direction, in some embodiments. The second imaging area 613B extends further than, and generally covers a larger area than, the first imaging area 613A. The camera 612B has a longer focal length than camera 612A, and is angled upward relative to camera 612A, to clearly capture objects (e.g., faces) at a greater distance than the opening 691. As seen in FIG. 6, the imaging areas 613A and 613B may overlap to some extent to avoid significant gaps in coverage. Other imaging area arrangements are also possible. For example, camera 612B may instead be located on top of the tamper detection device 602, and/or camera 612B may include multiple cameras situated on different sides of the tamper detection device 602, such that the second imaging area 613B extends in 360 degrees around (e.g., around the long axis of) the tamper detection device 602.

It is understood that many other designs for the tamper detection device 102 are possible using the principles disclosed herein. For example, the connecting means 104 may have a shorter clip or bracket (or a clip or bracket of manually-adjustable length) to enable easier attachment to a can with a shallow ridge. Moreover, the example devices shown in FIGS. 2-6 may have additional features beyond those shown. For example, the devices of FIGS. 2A, 3, and 5 may include a reset button (e.g., a part of resetting means 124), similar to the reset button 418, that is not shown in the respective figures.

FIGS. 7A and 7B depict example charging cases for a tamper detection device, according to two alternative embodiments. The charging cases may be used as the charging device 180 of FIG. 1, for example.

Referring first to FIG. 7A, an embodiment is shown in which the tamper detection device 102 is placed into a cradle 782A of a charging case 780A. The tamper detection device 102 and cradle 782A may have corresponding exposed, electrical contacts to enable current to flow from the charging case 780A to the powering means 120 of the tamper detection device 102, thereby charging one or more rechargeable batteries of the tamper detection device 102. Alternatively, the charging case 780A (and the powering means 120 of the tamper detection device 102) may be configured to support wireless charging of the tamper detection device 102 when the device 102 is resting in the cradle 782A. In some embodiments, the charging case 780A includes a hinged or removable cap or cover, to secure and protect the tamper detection device 102 while the device 102 is in the cradle 782A and recharging. An LED indicator 784A may provide a visual indication of when the battery or batteries of the tamper detection device 102 is/are low on charge (e.g., by turning yellow or red, or flashing, etc.) or is/are charged to at least some threshold degree (e.g., by turning green, of by staying on continuously rather than flashing, etc.).

Referring next to FIG. 7B, an embodiment is shown in which the tamper detection device 102 connects to a charging case 780B via a connector 781B. The connector 781B may be a USB cable and the tamper detection device 102 and charging case 780B may have corresponding USB ports, for example. In other embodiments, other suitable connector types and ports may be used. On the end of the tamper detection device 102, the port provides an electrical connection to the powering means 120 to enable recharging of the one or more rechargeable batteries. The charging case 780B includes an indicator 784B, which may be similar to LED indicator 784A discussed above

While not shown in FIGS. 7A and 7B, the charging case itself may have one or more rechargeable batteries, and/or a port for charging the charging case (e.g., via a USB cable connection to a block charger or a laptop, etc.). In other embodiments, the charging device 180 of FIG. 1 is another device such as a docking station or a laptop, rather than a case.

In some embodiments, the charging case 780A or 780B includes a display (e.g., an LCD or LED display), not shown in FIG. 7A or 7B. In these embodiments, coupling of the tamper detection device 102 to charging case 780A or 780B (by placing device 102 in the cradle 782A or connecting the device 102 via the connector 781B, respectively) may allow the user to view or “replay” images from image store 136, and/or view other information stored by storage means 116 (e.g., time stamps associated with tampering attempts, etc.).

### IV. Example Tamper Detection Techniques

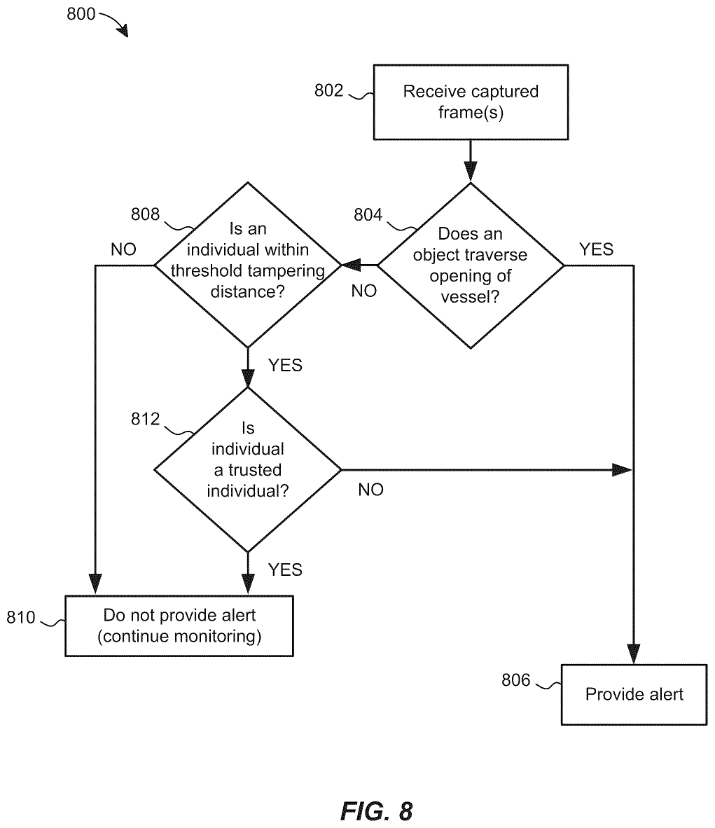

Operation of the tamper detection device 102 (e.g., device 202, 302, 402, 502, or 602), and more generally operation of the system 100, according to various example embodiments, will now be described in more detail with reference to FIG. 8. It is understood, however, that the operations shown in FIG. 8 provide only one of many possible embodiments.

FIG. 8 is a flow diagram of an example algorithm 800 for determining whether to alert a user of the tamper detection device 102, according to one embodiment. In the description below, the algorithm 800 is performed by processing means 114, and more specifically by tamper detection module 130. In other embodiments, however, the algorithm 800 may be performed by a different software module or module(s) stored in processing means 114 and/or another location.

At block 802 of the algorithm 800, tamper detection module 130 receives one or more frames (e.g., video frames) captured by one or more cameras of the imaging means 112. Tamper detection module 130 may receive the frame(s), store the frame(s) in image buffer 134, and/or process the frame(s) (e.g., in some or all of the subsequent blocks of algorithm 800 as described below) in real-time as the frame(s) are captured by the imaging means 112.

At block 804, tamper detection module 130 determines, by processing the frame(s), whether an object (e.g., any solid or liquid object) traverses the opening of a vessel (e.g., opening 191 of vessel 190). For example, tamper detection module 130 may determine whether an object crosses a “virtual lid” of the vessel, corresponding to a particular portion of (or an entirety of) the field of vision of one or more cameras. Depending on the embodiment, tamper detection module 130 may make only a binary determination of whether the opening was traversed without classifying the object, or may instead perform object recognition of any such object using a trained machine learning model. To perform object recognition tasks (e.g., object classification and possibly other tasks, such as object localization), tamper detection module 130 may, for example, use one or more convolutional neural networks (CNNs) (e.g., a region-based CNN (R-CNN) or fast R-CNN, a You Only Look Once (YOLO) model, etc.) stored in processing means 114, storage means 116, or elsewhere in memory of tamper detection device 102. Each CNN can include convolution, pooling, flattening, and fully connected layers, for example. In some embodiments, a single CNN may include hundreds or thousands of layers, and tens of thousands or hundreds of thousands of neurons, for example. Object detection may likewise be performed using a trained machine learning model (e.g., CNN), or may be performed by computer vision techniques that do not utilize machine learning.

In some embodiments, at block 804, tamper detection module 130 determines/concludes that an object is traversing the opening in response to detecting that, in at least one frame, an object is anywhere in the relevant imaging area (e.g., first imaging area 613A), or in response to detecting that an object is in the relevant imaging area of at least one frame with at least a threshold level of confidence. The imaging means 112 may have sufficient resolution, and the tamper detection module 130 may be configured, to detect any of various types of objects, depending on the embodiment. For example, block 804 may include detecting, and/or recognizing/classifying, objects shaped like pills, syringes, drops, powder packets, powder grains or collections of power grains (while being poured through the air), and so on.

In alternative embodiments, tamper detection module 130 determines whether an object traverses the opening using other criteria, such as whether two or more successive frames depict an object moving in a direction from an area external to the vessel to an area within the vessel. In still other embodiments, tamper detection module 130 uses a machine learning model (e.g., a CNN stored in processing means 114, storage means 116, or elsewhere in memory of tamper detection device 102) that is trained to analyze each frame, or series of frames, and output (e.g., with a particular confidence level), a prediction or inference as to whether the opening of the vessel (the virtual lid) was traversed, without any model providing an intermediate output indicating object detection or object classification. Tamper detection module 130 may determine that the opening was traversed if a threshold confidence level is exceeded, for example.

If traversal of the vessel opening by an object is detected at block 804, the algorithm 800 proceeds to block 806, and tamper detection module 130 provides an alert. Block 806 is discussed in greater detail below.

If traversal of the vessel opening by an object is not detected at block 804, the algorithm 800 proceeds to block 808, where tamper detection module 130 determines, by processing the captured frame(s), whether an individual is within a threshold tampering distance. For example, a second camera of tamper detection device 102 (e.g., camera 312B or 612B) may process frames of a particular imaging area (e.g., imaging area 613B) to determine whether any individual (e.g., a detected body, or specifically a detected face of a person, etc.) has moved within a predetermined threshold distance of the tamper detection device 102 and/or the vessel. Any suitable threshold distance may be used, such as 1, 3, 5, or 10 feet, for example. In some embodiments, the threshold tampering distance is inherently set based on limitations of the imaging means 112 (e.g., lack of sufficient focus beyond a certain distance), and may or may not vary based on environmental factors such as ambient lighting. Block 808 may include detecting faces using object recognition techniques (e.g., for all objects deemed to be within the threshold distance), e.g., using any suitable computer vision or machine learning model.

If tamper detection module 130 does not determine that any individual is within the threshold tampering distance at block 808, the algorithm 800 proceeds to block 810. At block 810, tamper detection module 130 does not provide an alert, and instead continues monitoring (e.g., continues to iterate algorithm 800 with respect to new frames or new multi-frame sequences).

If tamper detection module 130 determines that an individual is within the threshold tampering distance at block 808, however, the algorithm 800 proceeds to block 812. At block 812, tamper detection module 130 determines, by processing the captured frame(s) and based on trusted person data 140, whether the individual is a trusted individual. If tamper detection module 130 detects faces at block 808, for example, block 812 may include tamper detection module 130 using a suitable facial recognition technique to determine whether the face is a sufficient match with facial characteristic data stored in trusted person data 140. In these embodiments, trusted person data 140 stores facial characteristic data, and/or entire facial images, for one or more individuals that are trusted by the user of tamper detection device 102 (including, for example, the user, family of the user, and/or friends of the user). In another example embodiment, block 812 may include tamper detection module 130 processing audio (e.g., speech) received via a microphone of tamper detection device 102 (not shown in FIG. 1) and determining whether the audio data is a sufficient match with audio data stored in trusted person data 140. In these embodiments, trusted person data 140 stores voice characteristic data, and/or voice samplings, for one or more individuals that are trusted by the user of tamper detection device 102, including the user himself/herself.

If tamper detection module 130 determines that an individual is a trusted individual, the algorithm 800 proceeds to block 810 where, as noted above, tamper detection module 130 does not provide an alert and instead continues monitoring (e.g., continues to iterate algorithm 800 with respect to new frames or new multi-frame sequences).

If tamper detection module 130 does not determine that an individual is a trusted individual, however, the algorithm 800 proceeds to block 812 where, as noted above, tamper detection module 130 provides an alert.

More specifically, at block 806, tamper detection module 130 activates the alerting means 118 (e.g., causing one or more LEDs to emit light, and possibly triggering audio and/or vibration of other haptic output) by sending a control signal to the alerting means 118. Tamper detection module 130 may also take one or more other actions at block 806. For example, tamper detection module 130 may, at block 806, cause at least a subset of the images in image buffer 134 to be copied to (stored in) image store 136 for longer-term storage. In some embodiments, tamper detection module 130 also, at block 806, causes one or more subsequent/future images in image buffer 134 to be copied to (stored in) image store 136, to increase the odds of providing a more complete record of events (e.g., whether someone who appears to spike a drink puts something into his or her pocket immediately afterwards). Tamper detection module 130 may also store, in storage means 116, a record of the time (e.g., time of day, date, etc.) at which the traversal of the vessel opening was detected. In embodiments where tamper detection module 130 performs object recognition/classification, tamper detection module 130 may also store, in storage means 116, data indicating the type/class of object that was detected. In embodiments where tamper detection module 130 performs facial recognition, tamper detection module 130 may also store, in storage means 116, data indicating facial characteristics of one or more individuals, and/or associated identities of the individuals. For example, even images of (or other data associated with) a “trusted” individual may be stored at block 806 if tamper detection module 130 detects that an object traversed the vessel opening at block 804. Additionally or alternatively, at block 806, tamper detection module 130 may cause communication means 122 to transmit one or more messages with an alert notification, and/or any of the above-noted images and/or other data (e.g., time data, object type data, etc.), to mobile computing device 150 via wireless link 110.

It is understood that the blocks of algorithm 800 need not be performed in the order shown, or with the prioritization reflected by algorithm 800. In some embodiments, two or more of the blocks shown in FIG. 8 are performed at least partially in parallel (e.g., performing block 804 for a later group of frames while performing blocks 808 and 810 for an earlier group of frames).

In still another embodiment, blocks 804, 808, and 812 are replaced by a single block in which one or more machine learning models that consolidate the decision-making of tamper detection module 130. For example, tamper detection module 130 may use a CNN or other computer vision model to detect and/or classify objects within frames (or multi-frame sequences) from the imaging means 112, and a deep neural network may operate on outputs of the CNN or other model to predict or infer whether a potential tampering event has occurred. For example, a deep neural network may be trained (prior to storage in tamper detection device 102) to analyze a feature set that includes: (1) a count of how many people (e.g., detected faces, or detected faces of untrusted individuals, etc.) are within a first distance from the tamper detection device 102; (2) a count of how many people are within a greater, second distance from the tamper detection device 102; (3) the length of time that each person was within the respective threshold distance; and (4) a confidence level (0 to 100%) with which another model (e.g., CNN or other computer vision model) determines that the “virtual lid” has been breached. Based on these and/or other features/factors, the deep neural network may directly decide whether to proceed to block 806 or instead proceed to block 810, for each given time period or for each set of one or more frames.

### V. Example Tamper Detection Application

As noted above, the mobile computing device 150 stores a tamper detection application 170 providing various functions, such as communicating with the tamper detection device 102, providing outputs to the user based on activity detected by the tamper detection device 102, and/or enabling user management of the tamper detection device 102. That functionality is described in more detail here, according to various embodiments.

Tamper detection application 170 may be a user-downloadable application available to owners of a tamper detection device such as device 102, for example. In some embodiments, tamper detection application 170 provides a graphical user interface (GUI) (i.e., one or more GUI screens) on the display 156, and one or more functions that enable a user to configure tamper detection device 102 via the GUI.

Initially, a user may, via the GUI, pair the tamper detection device 102 to the mobile computing device 150 using the communication protocol of wireless link 110 and/or a higher-layer procedure managed by tamper detection application 170. After the pairing, tamper detection application 170 may support one or more other features for the user. As noted above, for example, the mobile computing device 150 may receive one or more messages with an alert notification, and/or certain images and/or other data (e.g., time data, object type data, etc.), from the tamper detection device 102 (via wireless link 110) when alerting means 118 of device 102 provides an alert (e.g., at block 806 of FIG. 8). More specifically, these messages/images/data can be received by tamper detection application 170, which in response takes one or more actions. In response to receiving an alert notification from tamper detection device 102, for example, tamper detection application 170 may cause display 156 to present a corresponding text alert (e.g., “ALERT: Your drink may have been spiked” or “DRINK TAMPERING DETECTED”, etc.). Tamper detection application 170 may cause the text alert to be displayed even if the mobile computing device 150 is in a non-active state such as a sleep mode. Additionally or alternatively, tamper detection application 170 may cause mobile computing device 150 to provide one or more other outputs (e.g., an audio alert and/or haptic feedback such as a vibration pattern).

As another example, in response to receiving one or more images from tamper detection device 102 (e.g., if tamper detection triggers such a transmission, as discussed above), tamper detection application 170 may store the received image(s) in image store 172 for later access. Similarly, in response to receiving other tampering data (e.g., time stamps, facial recognition data, etc.) from tamper detection device 102, tamper detection application 170 may store the received data in memory 154 for later access.

The GUI of tamper detection application 170 may provide one or more controls that enable the user to access (e.g., view or share) any images stored in image store 172 and/or any tampering data stored in memory 154. For example, a user might share such images/data with law enforcement if a drink spiking event (or attempt) occurred. The GUI may also, or instead, provide one or more controls that enable the user to access (e.g., view or share) a location of the tamper detection device 102. For example, the positioning means 126 may periodically (e.g., once per minute, once every 5 minutes, once per hour, etc.) determine the geographic location of tamper detection device 102 and transmit that location to the mobile computing device 150. In such an embodiment, communication means 122 preferably supports a wide area network (WAN) protocol, such as cellular, and communication means 122 uses that protocol to transmit locations to the mobile computing device 150, or to a server of a service that can then share the locations with the user (e.g., forward the locations to mobile computing device 150).

As yet another example, the GUI of tamper detection application 170 may provide one or more controls that enable the user to capture (e.g., via camera 158) and/or select (e.g., from a local or remote folder of digital photographs) images of one or more individuals that are to be considered “trusted” individuals (e.g., including the user himself/herself, and possibly close friends, family, etc.). Tamper detection application 170 can then use the wireless interface 160 to transmit the images (and/or facial characteristics that the tamper detection application 170 derives/identifies from those images, and that are usable by tamper detection module 130 to perform facial recognition as discussed above) to the tamper detection device 102 via wireless link 110, for storage as trusted person data 140.

In some embodiments, the GUI also includes a control that enables the user to reset the tamper detection device 102 via wireless link 110, when desired (e.g., instead of, or in addition to, having resetting means 124 in the device 102). Moreover, in some embodiments, the GUI includes one or more controls that enable the user to access/receive/download images from image store 136 (and/or other data stored in storage means 116) on-demand. For example, in response to user activation of such control(s), the tamper detection application 170 may send the tamper detection device 102 a request for the desired information/data via wireless link 110, and the tamper detection device 102 may respond with the requested information/data via wireless link 110. Other features and functionality may also be supported by the tamper detection application 170.

### VI. Example Tamper Detection Methods

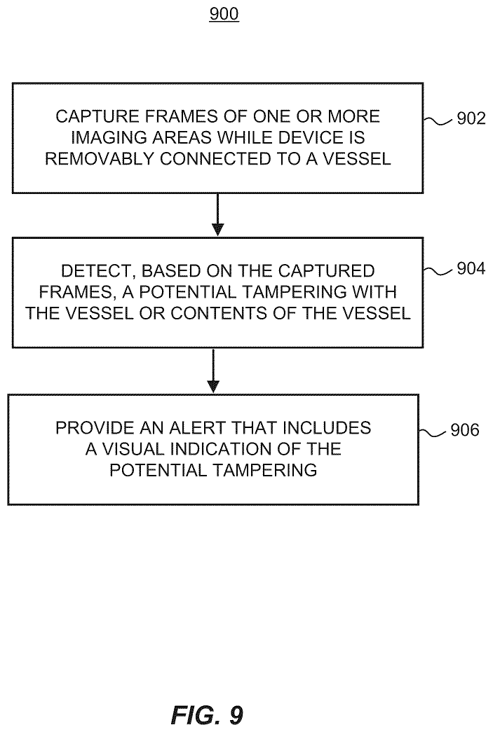

FIG. 9 is a flow diagram of an example method 900, performed by a device (e.g., tamper detection device 102, 202, 302, 402, 502, or 602), for protecting against drink or food tampering.

At block 902, frames of one or more imaging areas (e.g., imaging area 613A, or 613A and 613B, etc.) are captured (e.g., by imaging means 112) while the device is removably connected to a vessel (e.g., via connecting means 104, 204, 304, 404A and 404B, or 504A and 504B). The one or more imaging areas include at least one imaging area corresponding to an opening of the vessel.

At block 904, a potential tampering with the vessel (e.g., vessel 190 or a vessel for food), or contents of the vessel, is detected (e.g., by processing means 114 executing instructions of tamper detection module 130) based on the captured frames. While the detection is generally based on the monitoring/analysis of multiple captured frames, it is understood that the detection decision may turn on as little as one frame (e.g., an object being detected in the imaging area of the vessel opening for a single frame), or may depend on the collective processing of multiple frames (e.g., if the decision is based on the trajectory of an object, or based on detecting an object in the vessel opening area for at least two frames, etc.). Block 904 may be similar to blocks 804, 808, and/or 812 of FIG. 8, or may include any of the other tamper detection techniques discussed above in connection with FIG. 8, for example.

At block 906, an alert that includes a visual indication of the potential tampering is provided (e.g., by alerting means 118). Block 906 may be similar to block 806 of FIG. 8, for example.

In some embodiments, the method 900 includes one or more additional blocks not shown in FIG. 9. For example, the method 900 may include an additional block in which a subset of the captured frames is persistently stored in memory (e.g., by storage means 116) in response to detecting the potential tampering.

As another example, the method 900 may include an additional block in which data is wirelessly transmitted (e.g., by communication means 122) to an external mobile computing device (e.g., mobile computing device 150). The data may include one or more of the captured frames, and/or an indication of the potential tampering, and the wireless transmission may occur in response to detecting the potential tampering, for example. As another example, the method 900 may include yet another block in which one or more geographic locations of the device are determined (e.g., by positioning means 126), and the data may include an indication of the one or more geographic locations.

As another example, the method 900 may include additional blocks in which the device is coupled to a charging device (e.g., charging device 180, 780A, or 780B), and one or more batteries of the device are charged while the device is coupled to the charging device. The method 900 may also include a block in which one or more of the captured frames are transmitted, by the device, to the charging device for presentation on a display of the charging device.

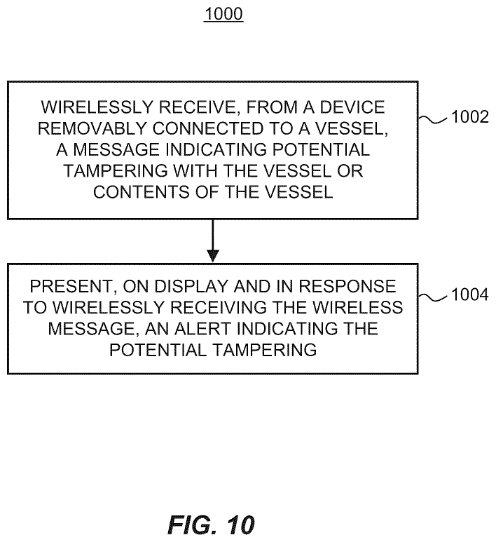

FIG. 10 is a flow diagram of an example method 1000, performed by a mobile computing device (e.g., mobile computing device 150) communicatively coupled to another device, for protecting against drink or food tampering.

At block 1002, a message indicating potential tampering with a vessel (e.g., vessel 190, or a vessel for food), or contents of the vessel, is wirelessly received (e.g., by processor 152 executing instructions of tamper detection application 170) from a device removably connected to the vessel (e.g., from device 102, 202, 302, 402, 502, or 602), e.g., via a link such as wireless link 110.

At block 1004, an alert indicating the potential tampering is presented (e.g., by processor 152 executing instructions of tamper detection application 170) on a display of the mobile computing device (e.g., on display 156) in response to wirelessly receiving the message. The alert may be a text-based message indicating that a potential tampering has occurred, e.g., as discussed above. Block 1004 may also include providing other alerts, such as an audio alert and/or haptic feedback.

In some embodiments, the method 1000 includes one or more additional blocks not shown in FIG. 10. For example, the method 1000 may include an additional block in which a message including one or more frames is wirelessly received, by the mobile computing device (or more specifically, by processor 152 executing instructions of tamper detection application 170) and from the device removably connected to the vessel, where the one or more frames are frames that were captured by the device removably connected to the vessel.

As another example, the method 1000 may include additional blocks in which an indication of one or more trusted individuals is received from a user of the mobile computing device and via a user interface presented on the display, and in which data representing facial features of each of the one or more trusted individuals is wirelessly transmitted (e.g., by tamper detection application 170 via wireless interface 160 and wireless link 110) to the device. The transmission may occur before or after the device is removably connected to the vessel.

### VII. Examples

The following list of examples reflects a variety of the embodiments explicitly contemplated by the present disclosure.

Example 1. A device for protecting against tampering, the device comprising: connecting means for removably connecting the device to a vessel; imaging means for capturing frames of one or more imaging areas while the device is removably connected to the vessel via the connecting means, the one or more imaging areas including at least one imaging area corresponding to an opening of the vessel; processing means for detecting, based on the captured frames, a potential tampering with the vessel or contents of the vessel; and alerting means for visually indicating the potential tampering.

Example 2. The device of example 1, further comprising: storage means for persistently storing at least a subset of the captured frames.

Example 3. The device of example 2, wherein the processing means is configured to cause the storage means to persistently store the subset of the captured frames in response to the processing means detecting the potential tampering.

Example 4. The device of example 1, further comprising: communication means for wirelessly transmitting data to an external mobile computing device.

Example 5. The device of example 4, wherein the processing means is configured to, in response to the processing means detecting the potential tampering, cause the communication means to wirelessly transmit one or more captured frames to the external mobile computing device.

Example 6. The device of example 4, wherein the processing means is configured to, in response to the processing means detecting the potential tampering, cause the communication means to wirelessly transmit an indication of the potential tampering to the external mobile computing device.

Example 7. The device of example 4, further comprising: positioning means for determining a geographic location of the device, wherein the processing means is configured to cause the communication means to wirelessly transmit an indication of one or more determined geographic locations of the device to the external mobile computing device.

Example 8. The device of example 1, wherein the connecting means includes a clip or a bracket.

Example 9. The device of example 1, wherein the imaging means includes a camera having a wide-angle lens.

Example 10. The device of example 1, wherein the imaging means includes one or more cameras collectively providing a 360-degree view.

Example 11. The device of example 1, wherein the imaging means captures frames covering substantially an entirety of the opening of the vessel.

Example 12. The device of example 1, wherein the imaging means includes a plurality of cameras configured to capture frames of different ones of the one or more imaging areas.

Example 13. The device of example 12, wherein the plurality of cameras includes: a first camera configured to cover a first imaging area that includes the opening of the vessel; and a second camera configured to cover a second imaging area that extends further from the device than the first imaging area.

Example 14. The device of example 1, wherein the processing means is configured to detect the potential tampering using a trained machine learning model.

Example 15. The device of example 1, wherein the alerting means includes one or more light-emitting diodes (LEDs).

Example 16. The device of example 1, wherein the processing means is configured to detect the potential tampering at least by detecting, based on the captured frames, whether an object traverses the opening of the vessel.

Example 17. The device of example 1, wherein the processing means is configured to detect the potential tampering at least by determining, based on the captured frames, whether an individual is within a threshold tampering distance.

Example 18. The device of example 1, wherein the processing means is configured to detect the potential tampering at least by detecting, based on the captured frames, a face within one or more of the captured frames.

Example 19. The device of example 18, wherein the processing means is configured to detect the potential tampering further by determining whether the detected face is associated with a trusted individual.

Example 20. The device of example 1, further comprising: powering means for providing power to the device and for charging one or more batteries of the device when the device is coupled to a charging device.

Example 21. The device of example 20, wherein the charging device is a case configured to hold the device.

Example 22. The device of example 21, wherein the device is configured to transmit one or more of the captured frames to the case for presentation on a display of the case.

Example 23. The device of example 20, wherein the powering means includes a Universal Serial Bus (USB) port.

Example 24. A method for protecting against tampering, the method comprising: capturing, by a device, frames of one or more imaging areas while the device is removably connected to a vessel, the one or more imaging areas including at least one imaging area corresponding to an opening of the vessel; detecting, by the device and based on the captured frames, a potential tampering with the vessel or contents of the vessel; and providing, by the device, an alert that includes a visual indication of the potential tampering.

Example 25. The method of example 24, further comprising: persistently storing, by the device and in response to detecting the potential tampering, a subset of the captured frames in memory.

Example 26. The method of example 24, further comprising: wirelessly transmitting, by the device, data to an external mobile computing device.

Example 27. The method of example 26, wherein the data includes one or more of the captured frames, and wherein the wirelessly transmitting is in response to detecting the potential tampering.

Example 28. The method of example 26, wherein the data includes an indication of the potential tampering, and wherein the wirelessly transmitting is in response to detecting the potential tampering.

Example 29. The method of example 26, wherein: the method further comprises determining, by the device, one or more geographic locations of the device; and the data includes an indication of the one or more geographic locations.

Example 30. The method of example 24, wherein detecting the potential tampering includes using a trained machine learning model.

Example 31. The method of example 24, wherein providing the alert includes activating one or more light-emitting diodes (LEDs) of the device.

Example 32. The method of example 24, wherein detecting the potential tampering includes detecting, based on the captured frames, whether an object traverses the opening of the vessel.

Example 33. The method of example 24, wherein detecting the potential tampering includes determining, based on the captured frames, whether an individual is within a threshold tampering distance.

Example 34. The method of example 24, wherein detecting the potential tampering includes detecting, based on the captured frames, a face within one or more of the captured frames.

Example 35. The method of example 34, wherein detecting the potential tampering further includes determining whether the detected face is associated with a trusted individual.

Example 36. The method of example 24, further comprising: coupling to a charging device; and charging one or more batteries of the device while the device is coupled to the charging device.

Example 37. The method of example 36, further comprising: transmitting, by the device, one or more of the captured frames to the charging device for presentation on a display of the charging device.

Example 38. A method for protecting against tampering, the method comprising: wirelessly receiving, by a mobile computing device and from a device removably connected to a vessel, a message indicating potential tampering with the vessel or contents of the vessel; and presenting, on a display of the mobile computing device and in response to wirelessly receiving the message, an alert indicating the potential tampering.

Example 39. The method of example 38, further comprising: wirelessly receiving, by the mobile computing device and from the device removably connected to the vessel, a message including one or more frames captured by the device.

Example 40. The method of example 38, further comprising: receiving, from a user of the mobile computing device and via a user interface presented on the display, an indication of one or more trusted individuals; and wirelessly transmitting, by the mobile computing device and to the device, data representing facial features of each of the one or more trusted individuals.

Example 41. A mobile computing device configured to perform the method of any one of examples 38-40.

Example 42. One or more non-transitory, computer-readable media storing instructions that, when executed by one or more processors of a mobile computing device, cause the mobile computing device to perform the method of any one of examples 38-40.

### VIII. Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for detecting drink or food tampering through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A device for protecting against tampering, the device comprising:
connecting means for removably connecting the device to a vessel;
imaging means for capturing frames of one or more imaging areas while the device is removably connected to the vessel via the connecting means, the one or more imaging areas including at least one imaging area corresponding to an opening of the vessel;
processing means for detecting, based on the captured frames, a potential tampering with the vessel or contents of the vessel; and
alerting means for visually indicating the potential tampering.

2. The device of claim 1, further comprising:
storage means for persistently storing at least a subset of the captured frames.

3. The device of claim 2, wherein the processing means is configured to cause the storage means to persistently store the subset of the captured frames in response to the processing means detecting the potential tampering.

4. The device of claim 1, further comprising:
communication means for wirelessly transmitting data to an external mobile computing device.

5. The device of claim 4, wherein the processing means is configured to, in response to the processing means detecting the potential tampering, cause the communication means to wirelessly transmit one or more captured frames to the external mobile computing device.

6. The device of claim 4, wherein the processing means is configured to, in response to the processing means detecting the potential tampering, cause the communication means to wirelessly transmit an indication of the potential tampering to the external mobile computing device.

7. The device of claim 1, wherein the connecting means includes a clip or a bracket.

8. The device of claim 1, wherein the imaging means includes a camera having a wide-angle lens.

9. The device of claim 1, wherein the imaging means includes one or more cameras collectively providing a 360-degree view.

10. The device of claim 1, wherein the imaging means captures frames covering substantially an entirety of the opening of the vessel.

11. The device of claim 1, wherein the processing means is configured to detect the potential tampering using a trained machine learning model.

12. The device of claim 1, wherein the processing means is configured to detect the potential tampering at least by detecting, based on the captured frames, whether an object traverses the opening of the vessel.

13. The device of claim 1, wherein the processing means is configured to detect the potential tampering at least by determining, based on the captured frames, whether an individual is within a threshold tampering distance.

14. The device of claim 1, wherein the processing means is configured to detect the potential tampering at least by (i) detecting, based on the captured frames, a face within one or more of the captured frames, and (ii) determining whether the detected face is associated with a trusted individual.

15. The device of claim 1, further comprising:
powering means for providing power to the device and for charging one or more batteries of the device when the device is coupled to a charging device.

16. A method for protecting against tampering, the method comprising:
capturing, by a device, frames of one or more imaging areas while the device is removably connected to a vessel, the one or more imaging areas including at least one imaging area corresponding to an opening of the vessel;
detecting, by the device and based on the captured frames, a potential tampering with the vessel or contents of the vessel; and
providing, by the device, an alert that includes a visual indication of the potential tampering.

17. The method of claim 16, further comprising:
persistently storing, by the device and in response to detecting the potential tampering, a subset of the captured frames in memory.

18. The method of claim 17, further comprising:
wirelessly transmitting, by the device, data to an external mobile computing device, wherein the data includes at least one of (i) one or more of the captured frames or (ii) an indication of the potential tampering, and wherein the wirelessly transmitting is in response to detecting the potential tampering.

19. A method for protecting against tampering, the method comprising:
wirelessly receiving, by a mobile computing device and from a device removably connected to a vessel, a message indicating potential tampering with the vessel or contents of the vessel; and
presenting, on a display of the mobile computing device and in response to wirelessly receiving the message, an alert indicating the potential tampering.

20. The method of claim 19, further comprising:
wirelessly receiving, by the mobile computing device and from the device removably connected to the vessel, a message including one or more frames captured by the device.
